(19) United States
(12) Patent Application Publication
(10) Pub. No.: US 2007/0217628 A1
(43) Pub. Date: Sep. 20, 2007

(54) Two-wire microphone circuit

(75) Inventor: Steven E. Boor, Plano, TX (US)

Correspondence Address: FITCH EVEN TABIN AND FLANNERY, 120 SOUTH LA SALLE STREET, SUITE 1600, CHICAGO, IL, 60603-3406, US

(73) Assignee: Knowles Electronics, LLC, Itasca, IL (US)

(21) Appl. No.: 11/527,430

(22) Filed: Sep. 26, 2006

Related U.S. Application Data
(60) Provisional application No. 60/783,688, filed on Mar. 17, 2006.

(51) Int. Cl. H04R 3/00

(52) U.S. Cl. 381/111

(57) ABSTRACT

A first circuit stage comprises at least one NMOS transistor and is coupled to a microphone transducer. A coupling circuit is coupled to the first circuit stage. A second circuit stage is adapted to receive signals from the first circuit stage via the coupling circuit and buffer the signals. The first circuit stage, the second circuit stage, and the coupling circuit reside completely within a microphone housing. A first contact member extends externally from the microphone housing and is electrically coupled to an output of the second circuit stage. The first contact member is adapted to selectively receive power from an external power supply to power the microphone circuit.

### CROSS-REFERENCES TO RELATED APPLICATIONS

This non-provisional application claims priority to U.S. Provisional Application No. 60/783,688, filed on Mar. 17, 2006, which is incorporated herein by reference in its entirety.

### TECHNICAL FIELD

This patent relates to transducers and specifically to microphones and microphone circuits used in all types of electronic devices.

### BACKGROUND OF THE INVENTION

Hearing instruments are in common use today and usually include a microphone circuit, amplification circuit, and receiver circuit. The microphone circuit receives audio energy and then converts this audio energy into electrical signals. The electrical signals may, in turn, be amplified (or otherwise processed) by the amplification circuit and forwarded to the receiver. The receiver circuit may then convert the amplified signals into audio signals that the user of the hearing instrument can hear. Other electronic devices may also utilize the above-mentioned circuits.

For protection and other purposes, the microphone circuit typically resides in a housing or case. Pins extend from the housing in order to provide a connection from. entities outside the case to the microphone circuit. For instance, in previous hearing instruments, three pins are used to provide these needed connections. Specifically, a power pin supplies power to the microphone circuit. In addition, an output pin allows the output of the circuit to be accessed. Further, a ground pin provides a ground connection for the microphone circuit. While providing needed access to the microphone circuit, these three-pin (“three-wire”) arrangements have several associated disadvantages. For example, three-pin arrangements are sometimes complex to use, expensive to manufacture, and difficult to maintain because of the use of three pins.

Commercial microphones have used two-pin (“two-wire”) arrangements in some other applications. Specifically, in two-wire arrangements, the output pin is used to provide both an output for the device and to receive power. Unfortunately, these previous two-wire approaches, while eliminating the need for an output pin, suffer from a variety of disadvantages and problems that make them unsuitable for application and use in hearing instruments or other electronic communication devices.

For instance, hearing instrument microphones (and microphones in other electronic devices) show improved performance when using a high pass filter (HPF). Unfortunately, previous two-wire approaches (e.g., using common source N-channel JFET amplifiers or Enhancement P-channel source follower buffers) are incapable of accommodating a HPF that is completely internal to the microphone. Other previous approaches have attempted to use a PMOS transistor as the initial stage in a microphone pre-amplifier. However, these approaches are also unsatisfactory for use in hearing instruments with high pass filters since it is difficult to achieve the maximum signal noise ratio (SNR) performance desired with the PMOS transistor, and the PMOS transistor limits the low frequency attenuation provided by the HPF.

Because of the above mentioned problems, satisfactory two-wire microphone circuits for use in electronic devices (e.g., hearing instruments) have been impossible to achieve resulting in reliance upon three-wire circuits. Consequently, manufacturing of these devices becomes more difficult and expensive, and the reliability of the devices also decreases. In addition, some of the benefits of using high pass filters in two-wire microphones (e.g., highly improved sensitivity stability, reduced susceptibility to wind noise, road noise, and other low frequency sounds, better manufacturability and matching of microphones for directional applications, and significantly improved transient overload characteristics) have not been taken advantage of either.

### BRIEF DESCRIPTION OF THE DRAWINGS

For a more complete understanding of the disclosure, reference should be made to the following detailed description and accompanying drawings wherein:

FIG. 1 is a block diagram of a microphone circuit according to the present invention;

FIG. 2 is circuit diagram of a microphone buffer circuit according to the present invention; and

FIG. 3 is a circuit diagram of a microphone pre-amplifier circuit according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention.

Approaches are provided that allow two-wire connections for the microphone to be used in electronic devices (e.g., hearing instruments or other instruments that use low power). In addition, these approaches allow for inclusion of a high pass filter (HPF) or other types of processing or coupling circuits that completely reside within the microphone housing. Consequently, since two-wire approaches can be utilized, manufacturing costs and complexities are reduced. Reliability of these devices is also enhanced. Moreover, the inclusion of high pass filters or other types of processing or coupling circuits allows the devices to have enhanced performance characteristics such as highly improved sensitivity stability, reduced susceptibility to wind noise, road noise, and other low frequency sounds, better manufacturability and matching of microphones for directional applications, and improved transient overload characteristics.

The approaches provided herein are applicable to a variety of types of electronic devices. For example, these approaches may be used in hearing instruments, electronic communication devices (e.g., headsets, cellular telephones, MP3 players), or portable electronic devices (e.g., personal or laptop computers). Other examples of applicable devices are possible.

In many of these embodiments, a first circuit stage comprises at least one NMOS transistor and is coupled to a microphone transducer. A coupling circuit is coupled to the first circuit stage. A second circuit stage is adapted to receive signals from the first circuit stage via the coupling circuit and buffer the signals. The first circuit stage, the second circuit stage, and the coupling circuit reside completely within a microphone housing. A first contact member extends externally from the microphone housing and is electrically coupled to an output of the second circuit stage. The first contact member is adapted to selectively receive power from an external power supply to power the microphone circuit.

The coupling circuit may comprise a high pass filter (HPF) circuit or some other processing or coupling circuit. In this regard, the HPF circuit may include at least one resistor and at least one capacitor.

The second circuit stage may be a buffer. In this regard, the second circuit stage may comprise at least one PMOS transistor. The second circuit stage may also comprise an amplification circuit. In this regard, the amplification circuit may include at least one NMOS transistor.

In others of these embodiments, a second contact member extends externally from the microphone housing and is electrically coupled to an external circuit ground and at least one of the following: the first circuit stage, the second circuit stage, the coupling circuit, and one or more biasing networks. The second contact member provides the second wire in a two-wire connection.

The different circuit stages mentioned above may reside on various electrical components. For instance, the first and second circuit stages may reside on the same integrated circuit. Alternatively, the first circuit stage may reside at least partially on a first integrated circuit and the second circuit stage resides at least partially on a second integrated circuit.

Thus, approaches are provided that allow for the use of two-wire connections in hearing instruments and other electronic devices. The approaches may also provide for the inclusion of a high-pass filter or other type of processing or connection circuit within the microphone housing to improve the performance of the microphone circuit and the overall device. In addition, manufacturing costs and complexities are reduced, and the reliability of the microphone circuit and the device is improved.

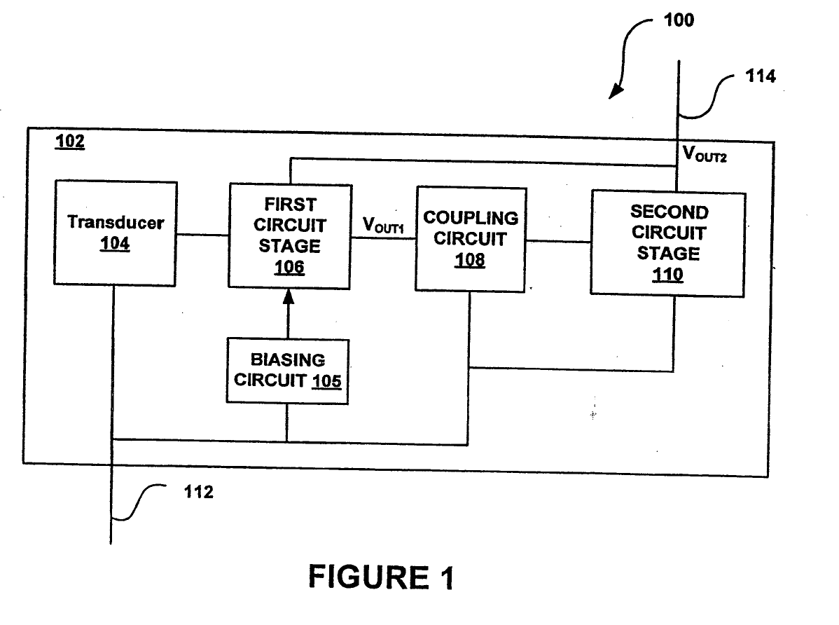

Referring now to the drawings and specifically to FIG. 1, one example of a microphone circuit 100 is described. The microphone circuit 100 includes an electret transducer 104, a first circuit stage 106, a coupling circuit 108, and a second circuit stage 110. Many of the components of the microphone circuit 100 reside within a microphone housing 102. For example, the first circuit stage 106, coupling 108, and second circuit stage 110 are contained within the housing 102. The electret transducer 104 is preferably completely contained within the housing 102, but may be partially positioned outside the housing so as to be able to receive acoustic energy from outside sources. A first pin 112 is coupled to and extends from at least one of the elements (a typical configuration has connections to elements 104, 105, 108, and 110) and a second pin 114 is coupled to and extends from at least the second circuit stage 110 (a typical configuration has connections to elements 106 and 110). It will be understood that the positioning, sizing, values, and dimensions of the components shown in FIG. 1 will vary as known to those skilled in the art and may depend upon various factors such as the particular materials used and the needs of the user.

The electret transducer 104 is an electret condenser microphone that converts acoustic (sound) energy into electrical signals. For example, the transducer may be any type of transducer useful in hearing instruments or other electronic devices.

The first circuit stage 106 comprises one or more NMOS transistors, for example, one or more Depletion NMOS transistors. Advantageously, Depletion NMOS transistors often have a significant (e.g., approximately two times) advantage in transconductance to capacitance (Gm/C) ratio, thereby improving the signal to noise ratio (SNR). Additional components may also be employed in the first stage besides the one or more NMOS transistors to aid or improve their functionality or to provide other functionality.

The first circuit stage 106 (e.g., a Depletion NMOS transistor) forms a first impedance buffer stage and couples directly to the electret transducer 104. A biasing network 105 provides a constant current to the first circuit stage 106. For example, when a Depletion mode NMOS transistor is used, the biasing network 105 may set the Drain-Source current of the NMOS transistor (used in the first circuit stage 106) by using a low-noise, constant current source formed by another Depletion NMOS transistor and a resistor. In alternate examples, other low-noise reference current generation approaches can be used.

Because the first circuit stage 106 is biased at a constant current, highly effective audio signal isolation is achieved between the output of the first circuit stage 106 (e.g., the Source terminal of Depletion mode NMOS transistor that has been labeled VOUT1) and the output of the second circuit stage 110 (the output pin 114, which is the external output of the microphone, and labeled VOUT2). This isolation occurs so long as the external power source that provides biasing to the circuit 100 provides a current which is appreciably larger than that used to bias the first circuit stage 106.

In addition to a Signal Noise Ratio (SNR) performance advantage provided, the audio signal isolation of the present approach allows significantly better signal attenuation at low audio frequencies below the High Pass filter corner frequency as compared to previous approaches. The isolation also helps to improve the immunity of the microphone to interference from wind, road, and other environmental noise sources. Moreover, the electrical isolation of the first circuit stage 106 and the second circuit stage 110 allows for additional components (such as the coupling circuit 108) to be inserted between the two stages.

The coupling circuit 108 comprises a circuit that is connected in series with and couples the first and second circuit stages 106 and 110. The coupling circuit 108 may also provide signal processing enhancements for the circuit 100 that improve the performance characteristics of the circuit 100. In this regard, the coupling circuit may be a high pass filter using one or more capacitors and one or more resistors. For example, the high pass filter may have components that are selected to provide −3 dB HPF corner frequency. In addition, additional HPFs may be used to drive a substrate of the integrated circuit or circuits (where elements 105, 106, 108, and 110 are formed) and act to shield and/or guard out stray parasitic capacitances inside of the microphone housing 102 to achieve additional improvements in SNR performance for the assembled microphone. In other examples, low-pass filters, band-pass filters, or any other type of coupling and/or processing circuit may be used as the coupling circuit 108. These examples may employ any combination of components. In some examples, the coupling circuit 108 may be omitted.

The second circuit stage 110 provides a variety of functions in the microphone circuit 100. For example, the second circuit stage 110 stage may provide buffering functions. In this case, the second circuit stage 110 may include a PMOS transistor.

In other examples, the second circuit stage 110 may be a pre-amplifier circuit and serve to amplify the signal received from the first circuit stage 106 via the coupling circuit 108. In this case, the second circuit stage 110 provides signal amplification and may consist of one or more Enhancement NMOS transistors and a biasing network.

The microphone housing 102 may be formed from plastic, metal or other suitable material and is used to protect the circuit 100. The first pin 112 is any connector or connector arrangement that is used to provide a circuit ground to the components of the circuit 100. The second pin 114 is any connector or connector arrangement, which provides an external output for the circuit 100. In addition, power is applied to the pin 114 to provide power to the various components of the microphone circuit 100.

In one example of the operation of the system of FIG. 1, the first circuit stage 106 (e.g., at least one NMOS transistor) receives signals from the microphone transducer 104. These signals are audio signals from outside sources such as human speech, music, or any other type of audio energy. The coupling circuit 108, which may be a high pass filter, processes the signals received from the first circuit stage 106. The coupling circuit 108 improves the signal quality, for instance, by providing highly improved sensitivity stability, reduced susceptibility to wind noise, road noise, and other low frequency sounds, or improved transient overload characteristics. The type and values of the components used in the coupling circuit 108 are selected to provide the desired characteristic improvement.

The second circuit stage 110 receives signals from the coupling circuit 108 and buffers the signals. If the second circuit stage 110 is an amplifier, the signals are amplified as well. The pin 114 provides an output from the second circuit stage 110 and receives power from an external power supply to power the microphone circuit 100. The pin 112 supplies ground to the circuit 100. Consequently, only external two pins are used in the microphone circuit 100, thereby providing a two-wire arrangement.

In one approach, the various components of the above-described microphone circuits (e.g., resistors, capacitors, and transistors) are produced and isolated from one another on a single integrated circuit (IC). Alternatively, two buffer stages (e.g., the first circuit stage 106 and the second circuit stage 110) and/or components could also reside on two integrated circuits that are electrically coupled together. In this regard, the integrated circuits may be separate IC chips or thick-film components screened on the hybrid circuit board of the microphone.

In one example, the first circuit stage 106 resides on a first component (e.g., a first IC) and the second circuit stage 110 resides on a second component (e.g., a second IC). The other components (e.g., the high pass filter) may reside on the first, second, or other integrated components.

The integrated circuits may be manufactured from commercially available Silicon BiCMOS IC technologies which have process extensions that allow for the implants and diffusions necessary to fabricate and electrically isolate Low Threshold Voltage Depletion NMOS, Enhancement NMOS, and Enhancement PMOS transistors onto a single Silicon IC. BiCMOS technology also allows the diodes, resistors, capacitors, and ESD protection devices that may be used for the integration of complete, high performance, two-wire microphone circuits onto the same Silicon integrated circuit chip. Alternatively, other manufacturing processes or combinations of manufacturing processes may be used.

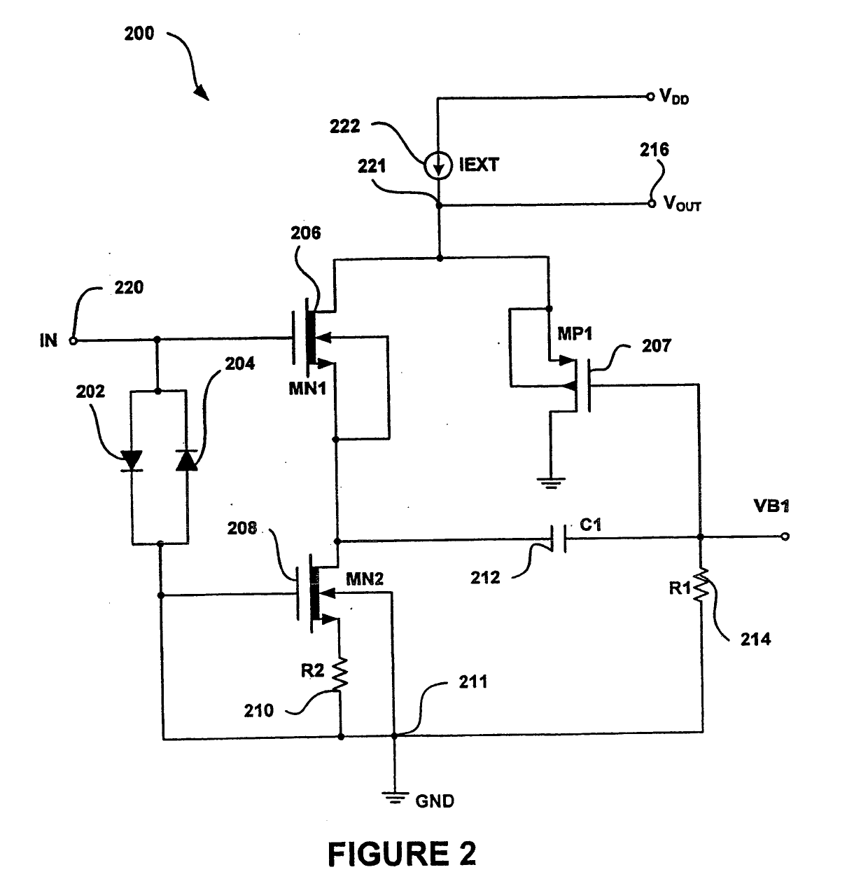

Referring now to FIG. 2, an example of a microphone buffer circuit 200 is described. A Depletion NMOS transistor 206 (MN1) (or transistors) forms a first impedance buffer stage and is coupled directly to a microphone electret transducer (not shown) through terminal node 220 (labeled “IN”). Additional components may also be employed in addition to the NMOS transistor 206 to aid or improve its functionality or to provide other functionality.

Direct Current (DC) biasing for node 220 is achieved by connecting anti-parallel diodes 202 and 204 between node 220 and a reference voltage, which in this example is ground. The biasing network, which sets the drain-source current of transistor 206, consists of a low-noise, constant current source formed by a Depletion NMOS transistor 208 (MN2) and resistor 210 (R2). However, the biasing network could be implemented via other low-noise IREF generation approaches. In one example, the resistor 210 is 7K ohms. Other values may also be used.

An electrical connector 221 extends externally from the circuit and provides two functions. First, the connector 221 allows an external power source 222 (e.g., from a battery) to power the circuit 200. In addition, the output (VOUT) of the circuit 200 may be sampled via the connector 221. It will be understood that the power source 222 is actually external to the circuit 200. The power source 222 (e.g., a battery) may provide a current IEXT and voltage Vdd and may be a low noise current source for use in low power supply voltage portable electronic applications (e.g., Hearing Instruments applications which operate off of a single battery cell and that typically provide low voltages of 1.3V to 1.6V).

A second impedance buffer stage is formed by an Enhancement PMOS transistor 207 (MP1) and the external current source 222. The input to the second buffer stage, (node VB1), is biased to a VREF (which happens to be GND in this example) through a resistor 214 (R1). In this example, resistor 214 has a value of 3.88 M ohms. Other values are possible. In other examples, the PMOS transistor 207 may be any other kind of P-type transistor, for instance, a lateral or vertical PNP transistor having low noise and reasonably high Beta characteristics.

Because the transistor 206 is biased at a constant current, highly effective audio signal isolation is achieved between the output of the first impedance buffer stage (the Source terminal of transistor 206) and the output of the circuit second stage (node 216 labeled as VOUT, which is the external output of the microphone). Isolation is maintained so long as the external power source 222 that provides biasing to the circuit 200 provides a current which is appreciably larger than that used to bias the transistor 206 (i.e. the current generated by transistor 208 and resistor 210), and so long as transistor 206 operates in its saturation region of operation. In addition to the SNR performance advantages of this circuit, the audio signal isolation of this approach allows significantly better signal attenuation at low audio frequencies below the High Pass filter corner frequency of previous approaches. This helps to improve the immunity of the microphone to interference from wind, road, and other environmental noise sources.

The electrical isolation of the two circuit stages allows for the provision of an electronic High Pass filter (HPF) network (capacitor 212 (C1) and resistor 214 (R1) to set the effective −3 dB HPF corner frequency) to couple the output of the first buffer stage to the input of the second stage while effectively maintaining all of the desired performance characteristics described previously. In addition, a second electronic HPF network can also be provided to drive the substrate of the integrated circuit and act as a means to shield and/or guard out stray parasitic capacitances inside of the microphone case to achieve even better overall SNR performance from the assembled microphone. In one example, the capacitor 212 is a 329 pF capacitor. Other values are possible.

In one example of the operation of the circuit 200, the biasing current is typically set by the transistor 208 and resistor 210 to be 2.5 to 5 μA. The external biasing current 222 of the buffer circuits (IEXT) is typically provided to be from 17-25 μA. In so doing, the total power consumption of the circuit is reasonably low and comparable to previous three-wire miniature hearing instrument electret microphone buffer circuits or microphone circuits found in other electronic devices. This range of external biasing current also maintains exceptional low-noise microphone performance as well as provides low values for output resistance (ROUT) for the circuit 200 without excessive power consumption in the system.

As mentioned, only two circuit nodes (e.g., pins) are provided for external access to the circuit 200 (i.e., pins from the microphone are provided at VOUT (node 221) and GND (node 211)). For purposes of clarity, it will be understood that electrostatic discharge (ESD) protection and electromagnetic interference (EMI) filtering networks that may be used for these two external microphone pins are not shown. All other circuit nodes shown remain internal to the microphone case, with the node IN (node 220) being connected to the signal coming from the microphone electret transducer.

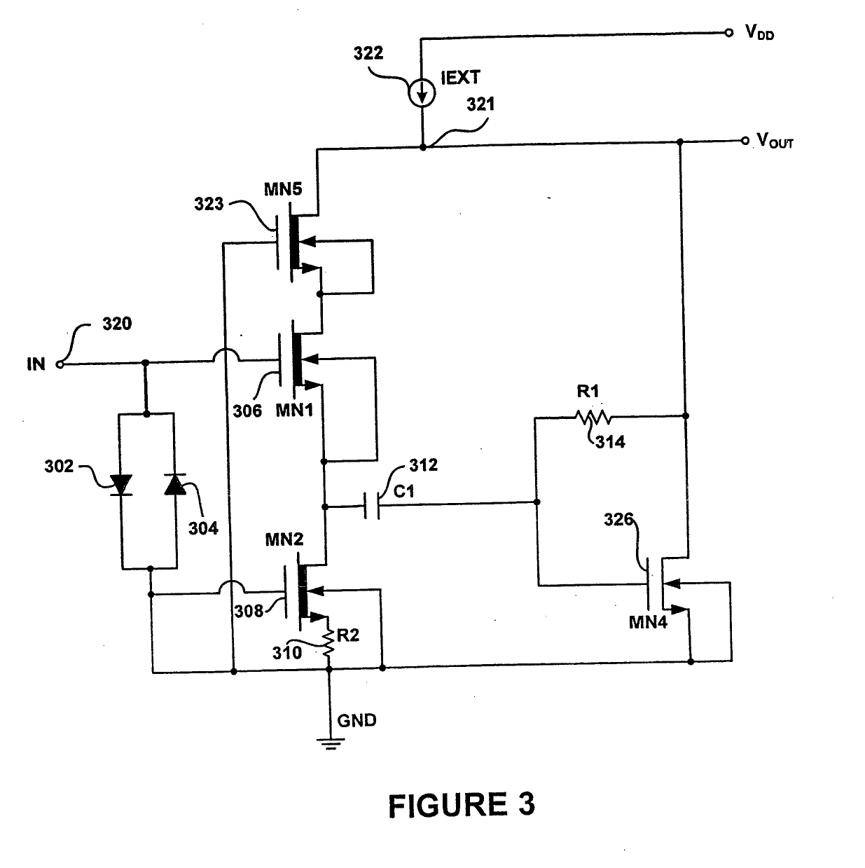

Referring now to FIG. 3, an example of a microphone pre-amplifier circuit is described. A Depletion NMOS transistor 306 (MN1) (or transistors) forms a first impedance buffer stage and is coupled directly to a microphone electret transducer (not shown) through terminal node 320 (labeled “IN”). Additional components may also be employed in addition to the NMOS transistor 306 to aid or improve its functionality or to provide other functionality.

Direct Current (DC) biasing for node 320 is achieved by connecting anti-parallel diodes 302 and 304 between node 320 and a reference voltage, which in this example is ground. The biasing network, which sets the drain-source current of transistor 306, consists of a low-noise, constant current source formed by a Depletion NMOS transistor 308 (MN2) and resistor 310 (R2). However, the biasing network could be implemented via other low-noise IREF generation approaches. In one example, the resistor 310 is 7K ohms. Other values are possible.

An electrical connector 321 (e.g., a pin or similar arrangement) extends externally from the circuit and provides two functions. The connector 321 allows an external power source 322 (e.g., from a battery having a voltage Vdd and current IEXT) to power the circuit 300. In addition, the output (VOUT) of the circuit 300 may be sampled via the connector 321. It will be understood that the power source 322 is external to the circuit 300. The power source 322 is a low noise current source for use in ultra-low power supply voltage portable electronic applications (e.g., Hearing Instruments applications which operate off of a single battery cell and that typically provide low voltages of between 1.3V to 1.6V).

A second circuit stage provides signal amplification functionality and is formed by an Enhancement NMOS transistor 326 (MN4) and its self-biasing network. The self-biasing network consists of a resistor 314(R1), which is connected between the Gate terminal of transistor 326 and VOUT. NMOS transistor 326 could be replaced with other kinds of N-type transistors, e.g. a lateral or vertical NPN transistor having low noise and reasonably high Beta characteristics. In one example, the resistor 314 is 3.7 M ohms. Other values are possible.

A Depletion NMOS device 323 (MN5) acts as a cascoding element, which prevents any Miller multiplication of the CGS capacitance of the transistor 306 from the amplified output at VOUT. This allows the overall circuit to provide exceptionally good gain and SNR performance.

The electrical isolation of the two circuit stages allows for the provision of an electronic High Pass filter (HPF) network (capacitor 312 (C1) and the resistor 314 (R1) to set the effective −3 dB HPF corner frequency) to couple the output of the first buffer stage to the input of the second stage while effectively maintaining all of the desired performance characteristics listed above. In addition, a second electronic HPF network can also be provided to drive the substrate of the integrated circuit or circuits and act to shield and/or guard out stray parasitic capacitances inside of the microphone case to achieve even better overall SNR performance for the assembled microphone.

As mentioned, only two circuit nodes (e.g., pins) are provided for external access to the circuit 300 (i.e., pins from the microphone are provided at VOUT (node 321) and GND (node 311)). For purposes of clarity, it will be understood that electrostatic discharge (ESD) protection and electromagnetic interference (EMI) filtering networks that may be used with these two external microphone pins are not shown. All other circuit nodes shown remain internal to the microphone case, with node IN (node 320) being connected to the signal coming from the electret transducer of the microphone.

Thus, approaches are provided that provide for the use of two-wire arrangements in hearing and other electronic devices. These approaches may also provide for the use of a high-pass filter or other type of processing and/or coupling circuit completely within the microphone housing so as to improve the performance of the microphone circuit and the overall device. In addition, manufacturing costs and complexities are reduced, and reliability of the microphone circuit and the device is improved. Further, when HPF circuits are incorporated into the microphone circuits described herein, the circuits enjoy favorable gain and transient setting characteristics, low noise, low output resistance (ROUT), and low power consumption.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone circuit comprising:
a first circuit stage, the first circuit stage comprising at least one NMOS transistor and being coupled to a microphone transducer;
a coupling circuit coupled to the first circuit stage; and
a second circuit stage, the second circuit stage being adapted to receive signals from the first circuit stage via the coupling circuit and buffer the signals.

2. The microphone circuit of claim 1 wherein the first circuit stage, the second circuit stage, and the coupling circuit reside completely within a microphone housing.

3. The microphone circuit of claim 1 further comprising a biasing circuit, the biasing circuit being coupled to the first circuit stage.

4. The microphone circuit of claim 3 further comprising a first connecting member extending externally from the microphone housing and being electrically coupled to at least one of: the coupling circuit, the biasing circuit and the second circuit stage.

5. The microphone circuit of claim 4 further comprising a second connecting member extending externally from the microphone housing and being electrically coupled to at least one of: the first circuit stage, the second circuit stage, and an external circuit ground.

6. The microphone circuit of claim 1 wherein the coupling circuit comprises a first high pass filter (HPF) circuit.

7. The microphone circuit of claim 6 wherein the first HPF circuit comprises at least one resistor and at least one capacitor.

8. The microphone circuit of claim 6 further comprising a second HPF circuit, the second HPF circuit driving a substrate of the microphone circuit.

9. The microphone circuit of claim 1 wherein the second circuit stage comprises at least one PMOS transistor.

10. The microphone circuit of claim 1 wherein the second circuit stage comprises at least one PNP transistor.

11. The microphone circuit of claim 1 wherein the second circuit stage comprises an amplification circuit.

12. The microphone circuit of claim 11 wherein the amplification circuit comprises at least one NMOS transistor.

13. The microphone circuit of claim 11 wherein the amplification circuit comprises at least one NPN transistor.

14. The microphone circuit of claim 1 wherein the first circuit stage resides at least partially on a first integrated circuit and the second circuit stage resides at least partially on a second integrated circuit.

15. The microphone circuit of claim 1 wherein the first circuit stage and the second circuit stage reside on a single integrated circuit.

16. A microphone buffer comprising:
an NMOS circuit stage, the NMOS circuit stage being coupled to a microphone transducer;
a first high pass filter (HPF) circuit stage coupled to the NMOS circuit stage;
a PMOS circuit stage, the PMOS circuit stage being adapted to receive signals from the NMOS circuit stage via the first HPF circuit stage, the PMOS circuit stage being adapted to be electrically isolated from the NMOS circuit stage; and
wherein a microphone housing completely encloses the NMOS circuit stage, the first HPF circuit stage, and the PMOS circuit stage.

17. The microphone buffer of claim 16 further comprising a first connecting member extending externally from the microphone housing and being electrically coupled to an output of the PMOS circuit stage, the first connecting member being adapted to selectively receive power from and external power supply.

18. The microphone buffer of claim 17 further comprising a second connecting member extending externally from the microphone housing and being electrically coupled to the NMOS circuit stage, the PMOS circuit stage, and an external circuit ground.

19. The microphone buffer of claim 16 wherein the NMOS circuit stage comprises at least one NMOS transistor and at least one biasing circuit.

20. The microphone buffer of claim 19 wherein the at least one biasing circuit is adapted to provide a constant current to the at least one NMOS transistor.

21. The microphone buffer of claim 16 wherein the PMOS circuit stage comprises at least one PMOS transistor.

22. The microphone buffer of claim 16 wherein the PMOS circuit stage comprises at least one PNP transistor.

23. The microphone buffer of claim 16 wherein the first HPF circuit stage comprises at least one capacitor and at least one resistor.

24. The microphone buffer of claim 16 further comprising a direct current (dc) biasing circuit, the dc biasing circuit being coupled to the NMOS circuit stage.

25. The microphone buffer of claim 16 wherein the NMOS circuit stage resides at least partially on a first integrated circuit and the PMOS circuit stage resides at least partially on a second integrated circuit.

26. The microphone buffer of claim 16 wherein the NMOS circuit stage and the PMOS circuit stage reside on a single integrated circuit.

27. The microphone buffer of claim 16 further comprising a second HPF circuit stage, the second HPF circuit stage driving a substrate of the microphone buffer.

28. A microphone pre-amplifier comprising:
an NMOS circuit stage, the NMOS circuit stage being coupled to a microphone transducer;
a first high pass filter (HPF) circuit stage coupled to the NMOS circuit stage;
an amplification circuit stage coupled to the first HPF circuit stage, the amplification circuit stage being adapted to receive and amplify signals from the NMOS circuit stage via the first HPF circuit stage;
wherein the NMSO circuit stage, first HPF circuit stage, and amplification circuit stage are completely enclosed by a microphone housing.

29. The microphone pre-amplifier of claim 28 further comprising a first connecting member extending externally from the microphone housing and being electrically coupled to an output of the amplifier circuit stage, the first connecting member being adapted to selectively receive power from an external power supply.

30. The microphone pre-amplifier of claim 29 further comprising a second connecting member extending externally from the microphone housing and being electrically coupled to the NMOS circuit stage, the amplifier circuit stage, and an external circuit ground.

31. The microphone pre-amplifier of claim 28 herein the NMOS circuit stage comprises at least one NMOS transistor and at least one biasing circuit.

32. The microphone pre-amplifier of claim 31 wherein the at least one biasing circuit is adapted to provide a constant current to the at least one NMOS transistor.

33. The microphone pre-amplifier of claim 28 wherein the amplification circuit stage comprises at least one NMOS transistor.

34. The microphone pre-amplifier of claim 28 wherein the amplification circuit stage comprises at least one NPN transistor.

35. The microphone pre-amplifier of claim 28 wherein the NMOS circuit stage at least partially resides on a first integrated circuit and the amplification circuit stage resides at least partially on a second integrated circuit.

36. The microphone pre-amplifier of claim 28 wherein the NMOS circuit stage and the PMOS circuit stage reside on a single integrated circuit.

37. The microphone pre-amplifier of claim 28 wherein the first HPF circuit stage comprises at least one resistor and at least one capacitor.

38. The microphone pre-amplifier of claim 7 further comprising a second HPF circuit stage, the second HPF circuit stage driving a substrate of the microphone pre-amplifier.
